(19) United States
(12) Patent Application Publication
(10) Pub. No.: US 2024/0423171 A1
(43) Pub. Date: Dec. 26, 2024

(54) Systems Observation Port

(71) Applicant: Jacob Isaac-Lowry, Lexington, KY (US)

(72) Inventor: Jacob Isaac-Lowry, Lexington, KY (US)

(21) Appl. No.: 18/813,005

(22) Filed: Aug. 22, 2024

Related U.S. Application Data
(60) Provisional application No. 63/509,530, filed on Jun. 22, 2023.

(51) Int. Cl. A01K 61/10; G06Q 50/02; G06T 1/00

(52) U.S. Cl. CPC A01K 61/10; G06Q 50/02; G06T 1/0007

(57) ABSTRACT

A device having an integrated CPU and at least one data port to receive at least one data signal from shipboard equipment for conversion and communication to a remote fishery management system, wherein the CPU converts a data signal into a format which is recognized and processible by a remote fishery management system for the purpose of communication and control of various shipboard equipment by the remote fishery management system.

### CROSS REFERENCE TO RELATED APPLICATIONS

The present application derives priority from U.S. Provisional Application 630/509,530.

### TECHNICAL FIELD

The apparatus of the present application relates generally to network interfaces and more specifically to a network interface which converts received data signals into a standardized format for use by a controller and converts commands from the controller into instructions that can be utilized by various devices and systems regardless of communication protocols and technologies.

### BACKGROUND

Monitoring the catch of small fishing vessels in offshore open-water fisheries is a challenging but critical task for governments. The reasons for such monitoring include conservation of marine species, ensuring sustainable fishing practices, protection of habitats, and compliance with regulations and international agreements.

Overfishing is a significant problem that can lead to the depletion of fish stocks, therefore conservation is a significant public interest and by monitoring the catch, governments can ensure that fish populations are maintained at sustainable levels. Monitoring helps to ensure compliance with fishing regulations, such as quotas, size limits, and restricted species. This is important to prevent illegal, unreported, and unregulated (IUU) fishing. Scientific Research is also a key public concern, and the data collected through monitoring can be used to better understand and protect fish populations and their habitats. Monitoring can be achieved through several means, including, onboard observers, electronic monitoring, logbooks, physical inspection upon docking, and remote sensing.

In some cases, a human observer is placed onboard the vessel to monitor the catch. They can identify species, count individuals, measure sizes, and observe fishing practices. This method provides high-quality data but can be expensive, and it is not practical for smaller vessels due to space and safety concerns.

Governments increasingly rely on technology for monitoring, including GPS tracking, video surveillance, and automatic identification systems (AIS). These electronic monitoring systems can provide detailed data on the location and activity of fishing vessels. Fishermen can also be required to keep detailed logbooks recording their catch. These records provide data on the species, sizes, and quantities of fish caught. Inspections at landing sites or ports allow for verification of the catch after the fishing trip. This method can be effective but is resource-intensive and relies on the honesty of the fishermen. In remote sensing, satellites and aerial surveillance can be used to monitor the activities of fishing vessels. These methods can cover large areas but may not provide sufficiently detailed information on the species and sizes of fish caught.

While these monitoring methods provide essential data for managing fisheries, they also impose burdens on small fishing operations. These burdens can include the financial cost of implementing monitoring technology or accommodating onboard observers, both of which can be a significant expense. These costs can be particularly burdensome for small-scale operations.

Moreover, working aboard a small fishing vessel is difficult and staffing is typically kept at a minimum. The administrative workload of keeping detailed logbooks and complying with other reporting requirements can be time-consuming and overly burdensome for a small crew. Additionally, some monitoring methods, like onboard observers, can disrupt the operation of small fishing vessels.

Governments try to balance these burdens with the need for sustainable fisheries management. In some cases, this may include financial assistance to help small-scale fishermen comply with monitoring requirements or the development of simplified reporting systems that reduce administrative workload.

### SUMMARY

The present application discloses a device that utilizes a data conversion module to process incoming signals, including proprietary signal formats, into a standard, universal protocol which is then fed to a Remote Fishery Management System, e.g., the Remote Fishery Management System (RFMS) described in U.S. Pat. No. 11,064,152, to permit a diverse array of sensors and cameras, e.g., a ship's existing onboard closed-circuit television (CCTV) system, to communicate with a portable, modular RFMS, for the purpose of capturing and integrating video and data from existing shipboard sensors, cameras, and other devices to permit the portable, modular, RFMS to perform its intended function of characterizing the catch regardless of format of the data stream fed to the system observation port device.

### BRIEF DESCRIPTION OF THE DRAWINGS

FIG. 1 depicts a view of an embodiment of the systems operation port of the present application.

### DETAILED DESCRIPTION

Many commercial fishing vessels already have CCTV cameras installed so that captains may observe fishing operations from the helm, for security/insurance, or other operational needs. As competing remote electronic monitoring systems intended for use with fisheries are essentially an expensive, customized CCTV camera systems themselves, these products requires vessels to install two sets of CCTV cameras onboard, which is expensive and redundant.

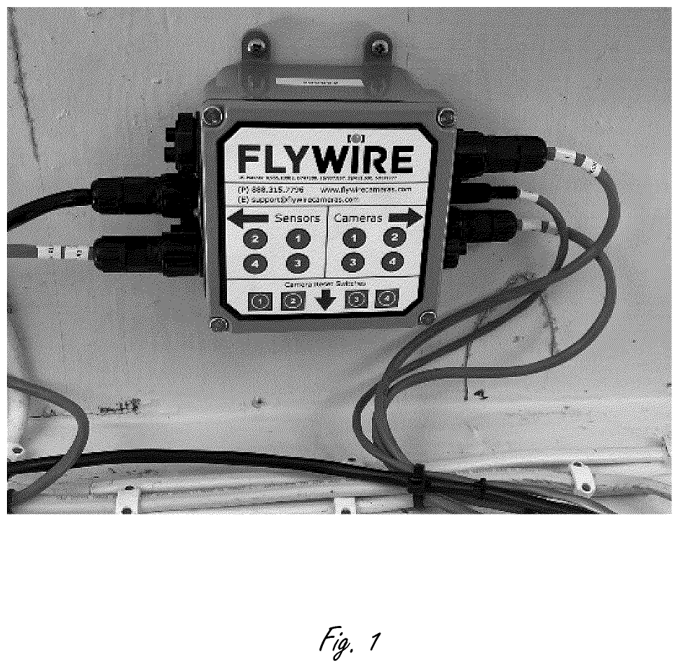

The Systems Observation Port (SOP) of the present application is depicted in FIG. 1 and is an advanced, highly versatile device engineered to connect with various types of sensors and cameras to facilitate comprehensive monitoring and recording of fishing activities, including each catch, on small fishing vessels for the purpose of enabling better yield management as well as confirming compliance with fishing regulations. The SOP enhances efficiency and accuracy in tracking fishing operations, by leveraging existing sensor and camera installations regardless of their technology.

The SOP integrates a modular, portable Remote Fishery Management Systems with an existing CCTV installation in order to utilize those existing camera feeds for additional data capture instead of requiring the installation of a duplicate set of cameras (or Monitoring Systems) on larger fishing vessels. The SOP is essentially a dongle that can be installed on a fishing vessel. The dongle, along with a set of sensors (e.g., pressure, rotation, limit switch, etc.) are installed/wired into the vessel's sub systems (e.g., hydraulic system, net drum, etc.) and powered by the vessel itself or alternatively a battery or generator. A CCTV system (specifically the controller) can be connected to one of the dongle ports as well. In this way video recordings between the Remote Fishery Management System and the existing CCTV system can be synchronized and therefore utilized.

The SOP utilizes a flexible, multi-channel input system designed to handle signals from diverse types of sensors, including but not limited to, depth sounders, GPS trackers, temperature sensors, motion sensors, and weight scale sensors. This enables it to collect a wide array of data related to the fishing process, such as the location, depth, temperature, motion, and weight of the catch. The SOP also provides support for multiple camera inputs, e.g., conventional CCTV, infrared, thermal imaging, and high-definition digital cameras, the interface can efficiently process feeds, even from different types of cameras concurrently, to give a comprehensive visual overview of fishing operations.

The SOP utilizes a data conversion module to process incoming data signals and generate an accurate, standardized data signal. This process involves translating proprietary or device-specific formats and protocols into a standard, universal protocol that is easier to process, analyze, and store and which the system's controller can use. The SOP incorporates a buffering system to accommodate disparities in data transmission rates or processing speeds among the various sensors and cameras. This buffering system ensures smooth, uninterrupted data flows and synchronizes inputs from different sources, allowing for precise timeline mapping of the captured data and video.

The SOP offers real-time and batch processing modes to fit different operational needs. Real-time processing provides instant conversion and transmission of data for immediate analysis, while batch processing allows data accumulation over a period for later processing and analysis. It is designed to be compatible with signal formats of existing technologies. Its universal design allows integration with various operating systems and communication protocols. The driver software is compatible with numerous operating systems, making it a plug-and-play solution for most systems. Designed with the harsh maritime conditions in mind, the SOP is encased in a rugged, waterproof casing that protects the sensitive electronics from moisture, salt, and vibrations. Its compact design ensures it can be easily accommodated in small boat environments.

Control algorithms in the Remote Fishery Management System's firmware utilize logic from a universal set of trigger inputs. A Remote Fishery Management System's hardware is utilized to communicate with a universal set of sensor inputs (e.g., analog, digital, etc.). The SOP is designed to accept universal sensor/trigger inputs and acts as a universal sensor interface which communicates data in a format the controller can utilize. The primary function of such a system is to receive, interpret, and translate signals from various types of sensors, and communicate that processed data to a universal controller.

Likewise, the SOP is programmed so that it can communicate universal trigger signals with logic which permit communication and control of various CCTV systems that require the receipt of specific, distinctive signals to that specific CCTV system that it is programmed to interpret and then execute programmed instructions. A plurality of SOP devices may be utilized to accommodate a plurality of shipboard equipment from which signals are to be converted and sent to and from the remote RFMS.

The present apparatus recognizes and addresses the previously-mentioned long-felt needs and provides utility in meeting those needs in its various possible embodiments. To one of skill in this art who has the benefits of this disclosure's teachings, other and further objects and advantages will be clear, as well as others inherent therein. The disclosures herein are not intended to limit the scope of the invention, merely to provide context with which to understand the patent claims.

What is claimed is:

1. A device having an integrated CPU programmed to convert data signals between a standardized format and various proprietary formats and at least one data port to receive and transmit said data signals between shipboard equipment and a remote fishery management, wherein said CPU converts said at least one data signal into a format which is recognized and processible by a remote fishery management system for the purpose of communication and control of various shipboard equipment by said remote fishery management system and converts said remote fishery management system trigger signals into trigger signals which can be recognized by said shipboard equipment.

2. The device of claim 1, wherein said shipboard equipment includes at least one of a sensor and an imaging system.

3. The device of claim 2, wherein said sensor includes at least one of depth sounders, GPS trackers, temperature sensors, motion sensors, and weight scale sensors.

4. The device of claim 3, wherein said device can process signals from different types of sensors concurrently.

5. The device of claim 2, wherein said imaging system includes at least one of a conventional CCTV, infrared, thermal imaging, and high-definition digital camera.

6. The device of claim 5, wherein said device can process signals from different types of cameras concurrently.

7. The device of claim 1, wherein said device utilizes a buffering system to accommodate disparities in at least one of data transmission rates and processing speeds among the various sensors and cameras.

8. The device of claim 1, further comprising a data storage for at least one of device data signal input and device data signal output for the purpose of enabling both real-time and batch processing modes to fit different operational needs.

9. The device of claim 1, wherein said CPU can convert signals from said remote fishery management system to at least one of proprietary and universal trigger signals which permits communication and control of various said shipboard sensors and imaging systems.

10. The method of integrating an existing fishing vessel's shipboard equipment with a remote fishery management system by receiving signals from said shipboard equipment that a remote fishery management system cannot process into a device which converts said signals into a format said remote fishery management system can process and use to perform catch characterization for reporting purposes.
